(19) United States
(12) Patent Application Publication
(10) Pub. No.: US 2024/0065293 A1
(43) Pub. Date: Feb. 29, 2024

(54) PET CHEW FORMULATION AND METHODS OF MAKING SAME

(71) Applicant: Spectrum Brands, Inc., Middleton, WI (US)

(72) Inventors: Gregory VAN EYK, Middleton, WI (US); Stephanie HULLVERSON, Middleton, WI (US); Tiffany POTTER, Middleton, WI (US)

(73) Assignee: Spectrum Brands, Inc., Middleton, WI (US)

(21) Appl. No.: 18/260,590

(22) PCT Filed: Jan. 6, 2021
(86) PCT No.: PCT/US2021/012368

§ 371 Date: Jul. 6, 2023

(51) Int. Cl. A23K 10/20; A23K 10/30; A23K 20/163; A23K 20/179

(52) U.S. Cl. CPC A23K 10/20; A23K 10/30; A23K 20/163; A23K 20/179

(57) ABSTRACT

The present disclosure related generally to an edible pet chew. The edible pet chew comprises a first sheet of grain-based material and a second sheet of flavored material for example jerky that is laminated with the first sheet to form alternating layers in the edible pet chew. An edible pet chew may also include a layer of hardened chewy plant base material and a layer sheet of a chewy edible material. The first and second layers are superimposed adjacent each other into a composite assembly with the first layer and second layer forming alternating layers in the composite assembly. The present disclosure related generally to an edible pet chew has a first sheet of plant base material and a second protein of flavored material comprising a meat jerky and an anti-oxidant rich material that is wrapped with the first sheet to form alternating layers in the edible pet chew.

### INTRODUCTION

Most pets are playful in nature, which endears the pet to the pet owner. However, this playful disposition may be manifest in a destructive manner. Pets may destroy shoes, furniture, curtains, and other objects while expressing their playfulness. Pet owners believe chew toys also distract the pet from chewing on other objects such as shoes or furniture. Chew toys are desirable for cleaning the teeth of dogs and other pets, providing for dental hygiene and resulting in better breath. A single visit to a pet supermarket makes it readily apparent that there is a wide selection of rawhide and other synthetic chew toys manufactured and shaped for dogs and other carnivorous pets to chew on.

Many of these chew toys have been made from synthetic materials such as plastic, for example, nylon or even rubber to provide a long lasting chew toy. These synthetic chew toys are be indigestible and may pose a health risk if the dog bites off a portion and swallows it. Secondly, these toys may lose a dog's interest because the toy typically has no flavor or other chew incentive.

Other chew toys are made from rawhide. Rawhide also has no inherent flavor and thus may lose a dogs interest after only a short chew time. To overcome the lack of flavor and taste of rawhide, many manufacturers have attempted to add flavor to the pet chew by adding jerky, natural flavors or even pig hide in addition to the rawhide. Flavors may also be injected into the rawhide, marinated into the rawhide, wrapped in the rawhide or impregnated into the rawhide.

Thus, there is a need for an edible pet chew formulated from alternative grain sources. There is also a need for an edible pet chew that has an outer layer that is free of rawhide and a second layer that is free from meat and animal byproducts. Further, there is a need for an antioxidant-rich edible pet chew. Moreover, what is needed is an improved edible pet chew that has an outer layer of hardened and chewable plant based material in conjunction with an inner layer of material that contains at least in part flavored content or actual dried or cured animal flesh content.

### Pet Chew Formulation and Methods of Making Same

In accordance with at least one embodiment of the invention, an edible pet chew has a layer of hardened chewy grain-base material and a second sheet of a chewy edible material. The first and second sheets are superimposed adjacent each other into a composite assembly with the first sheet and second sheet forming alternating layers in the composite assembly.

Preferably, the first sheet of grain base material includes a grain-based composition being wrapped about the second sheet. The first and second sheets wrapped into a roll form to form an interleaved spiral shape in cross-section with the first sheet substantially forming a hardened layer of the edible pet chew. The first sheet may be made from an initially malleable and hardenable mixture of grain-based protein and gelatin. A grain-based protein composition is desirably extrudable to form the first sheet. Only a small percentage of gelatin is needed, for example under 5% of the composition by weight, to provide enough malleability for extrusion, molding and other bending and forming.

In one embodiment, the edible pet chew has a tied knot at each end thereof to resemble epiphyses of a bone. The second sheet may be made from a grain-based material having flavor infused therein. Alternately, the second sheet may be formed from a meat composite bound with a binder. In one embodiment, the second sheet may be formed from a jerky of dried or cured animal flesh.

In accordance with another aspect of the invention, the edible pet chew includes a casing of hardened chewable grain-based material and a chewy edible member therein. Preferably, the outer casing is in the form of a first sheet that provides an outer layer of the edible pet chew. The chewy edible member therein is substantially inside the edible pet chew and may be a cured or dried animal flesh.

In accordance with another aspect of the invention, a method of forming an edible pet chew includes providing a grain-based mixture that is extrudable or sheetable and initially malleable forming the initially malleable grain-based mixture into a first sheet, providing a second sheet made from material having flavor, placing the first and second sheets in superimposed relation forming multiple layers and hardening the first sheet after it is formed with the second sheet. Preferably the first and second sheets are rolled together and preferably rolled with the first sheet forming an outer layer.

Preferably, the ends of the edible pet chew are tied into knots before hardening of the first sheet. Preferably, the first sheet is made from a grain-protein composition, and the second sheet is made from a meat based material. The first sheet is made from a grain base and glycerin composition, and the second sheet is made from a meat jerky. The method also includes wrapping the first sheet about the second sheet to form an outer layer of the edible pet chew.

In another embodiment of the invention to outer portion of grain-based material is injection molded to form one or more cavities in which the jerky can be inserted. Injection molding is the preferred method to produce a three dimensional shape. An alternative to injection molding the outer portion could be extrusion, co-extrusion, cold molding or compression molding. After the outer case is formed, the jerky can be inserted either wholly or partially into the formed cavities.

In one embodiment, the edible pet chew has a tied knot at each end thereof to resemble epiphyses of a bone. The second layer may be made from a plant-based material having flavor infused therein. Alternately, the second layer may be formed from a vegetable composite bound with a binder. In one embodiment, the second layer may be formed from a dried or cured vegetable or fruit mixture.

In accordance with another aspect of the invention, the edible pet chew includes a casing of hardened chewable plant based material and a chewy edible member therein. In one embodiment, the outer casing is in the form of a first layer that provides an outer layer of the edible pet chew. The chewy edible member therein is substantially inside the edible pet chew and may be a vegetable and/or fruit based mixture.

In accordance with another aspect of the invention, a method of forming an edible pet chew includes providing a plant based mixture that is extrudable or sheetable and initially malleable forming the initially malleable plant based mixture into a first layer, providing a second layer made from material having flavor, placing the first and second layers in superimposed relation forming multiple layers and hardening the first layer after it is formed with the second layer. In one embodiment, the first and second layers are rolled together and rolled with the first layer forming an outer layer.

In one embodiment, the ends of the edible pet chew are tied into knots before hardening of the first layer. In one embodiment, the first layer is made from a plant protein composition, and the second layer is made from a vegetable-based material. The first layer is made from a plant base and gelatin composition, and the second layer is made from a vegetable and/or fruit mixture. The method also includes wrapping the first layer about the second layer to form an outer layer of the edible pet chew.

In another embodiment of the invention to outer portion of the plant based material is injection molded to form one or more cavities in which the second layer can be inserted, injection molding is the preferred method to produce a three dimensional shape. An alternative to injection molding the outer portion could be extrusion, co-extrusion, cold molding or compression molding. After the outer case is formed, the second layer can be inserted either wholly or partially into the formed cavities.

Alternately, the second sheet may be formed from a meat composite and an antioxidant-rich based material bound with a binder. In one embodiment, the second sheet may be formed from a jerky of dried or cured animal flesh.

In accordance with another aspect of the invention, the edible pet chew includes a casing of hardened chewable plant based material and a chewy edible member therein. Preferably, the outer casing is in the form of a first sheet that provides an outer layer of the edible pet chew. The chewy edible member therein is substantially inside the edible pet chew and may be a cured or dried animal flesh combined with an anti-oxidant rich plant based material.

In other preferred embodiments, a method of forming an edible pet chew includes providing a plant based mixture that is extrudable or sheetable and initially malleable forming the initially malleable plant based mixture into a first sheet, providing a second sheet made from material having flavor material comprising a meat based composite and an antioxidant-rich plant based material, placing the first and second sheets in superimposed relation forming multiple layers and hardening the first sheet after it is formed with the second sheet. Preferably, the first and second sheets are rolled together and preferably rolled with the first sheet forming an outer layer.

Preferably, the ends of the edible pet chew are tied into knots before hardening of the first sheet. Preferably, the first sheet is made from a plant protein composition, and the second sheet is made from an anti-oxidant enhanced meat based material. The first sheet is made from a plant base and glycerin composition, and the second sheet is made from an anti-oxidant enriched meat jerky. The method also includes wrapping the first sheet about the second sheet to form an outer layer of the edible pet chew. In alternative embodiments, the second sheet comprise a cheese or cheese product. In other alternative embodiments, the second sheet comprises a Greek yogurt.

In another embodiment of the invention to outer portion of plant-based material is injection molded to form one or more cavities in which the jerky can be inserted. Injection molding is the preferred method to produce a three dimensional shape. An alternative to injection molding the outer portion could be extrusion, co-extrusion, cold molding or compression molding. After the outer case is formed, the anti-oxidant enhanced meat composite can be inserted either wholly or partially into the formed cavities.

### BRIEF DESCRIPTION OF THE DRAWINGS

FIG. 1 is a perspective view showing a first sheet of an alternative-grain based material with a second sheet of a meat based material laid over the first sheet in preparation of forming an edible pet chew in accordance with one embodiment of the invention;

FIG. 2 is a perspective view of one embodiments of the edible pet chew;

FIG. 3 is another embodiment having two knotted ends to stimulate the epiphyses of a bone with a diaphysis in the middle;

FIG. 4 is a top plan view showing a plurality of meat based strips placed on top of the first sheet in preparation of forming another alternate embodiment of a pet chew;

FIG. 5 is an alternative embodiment of an edible pet treat formed from the sheets shown in FIG. 4

FIG. 6 an alternate embodiment of an edible pet treat formed also from the sheets shown in FIG. 4;

FIG. 7 is a side view of another embodiment of an edible pet chew;

FIG. 8 is a perspective view of a pet chew with an outer molded casing with transverse holes for filling with an edible chewable material therein;

FIG. 9 is a perspective view of a pet chew with a molded outer casing with a longitudinal hole for filling with an edible chewable material therein; and

FIG. 10 is a perspective view of a pet chew with a molded outer casing with an alternate configuration.

FIG. 11 is a perspective view showing a first layer of a base material with a second layer laid over the first layer in preparation of forming an edible pet chew in accordance with one embodiment of the invention;

FIG. 12 is a perspective view of one embodiment of the edible pet chew;

FIG. 13 is another embodiment having two knotted ends to simulate the epiphyses of a bone with a diaphysis in the middle;

FIG. 14 is a top plan view showing a plurality of vegetable flavored strips placed on top of the first layer in preparation of forming another alternate embodiment of a pet chew;

FIG. 15 an alternate embodiment of an edible pet chew formed from the sheets shown in FIG. 14;

FIG. 16 an alternate embodiment of an edible pet chew formed also from the sheets shown in FIG. 14;

FIG. 17 is a side view of another embodiment of an edible pet chew;

FIG. 18 is a perspective view of a pet chew with an outer molded casing with transverse holes for filling with an edible chewable material therein;

FIG. 19 is a perspective view of a pet chew with a molded outer casing with a longitudinal hole for filling with an edible chewable material therein; and

FIG. 20 is a perspective view of a pet chew with a molded outer casing with an alternate configuration.

FIG. 21 is a perspective view showing a first sheet of a plant based material with a second sheet of an anti-oxidant rich meat based material laid over the first sheet in preparation of forming an edible pet chew in accordance with one embodiment of the invention;

FIG. 22 is a perspective view of one embodiments of the edible pet chew;

FIG. 23 is another embodiment having two knotted ends to stimulate the epiphyses of a bone with a diaphysis in the middle;

FIG. 24 is a top plan view showing a plurality of anti-oxidant rich meat based strips placed on top of the first sheet in preparation of forming another alternate embodiment of a pet chew;

FIG. 25 is an alternative embodiment of an edible pet treat formed from the sheets shown in FIG. 24

FIG. 26 an alternate embodiment of an edible pet treat formed also from the sheets shown in FIG. 24;

FIG. 27 is a side view of another embodiment of an edible pet chew;

FIG. 28 is a perspective view of a pet chew with an outer molded casing with transverse holes for filling with an edible chewable material therein;

FIG. 29 is a perspective view of a pet chew with a molded outer casing with a longitudinal hole for filling with an edible chewable material therein; and

FIG. 30 is a perspective view of a pet chew with a molded outer casing with an alternate configuration.

### DEFINITIONS

Unless otherwise specified, the following terms as used herein have the meanings provided below.

The term “about” generally refers to a range of numbers that one of skill in the art would consider equivalent to the recited value (i.e., having the same function or result). In many instances, the terms “about” may include numbers that are rounded to the nearest significant figure.

As used herein, the singular forms “a”, “an”, and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise.

Weight percent, percent by weight, wt. %, and the like are synonyms that refer to the concentration of a substance as the weight of that substance divided by the weight of the composition and multiplied by 100.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

As used herein the term “comprising” and variations thereof do not have a limiting meaning where these terms appear in the specification and claims.

As used herein the term, “consisting essentially of” in reference to a composition refers to the listed ingredients and does not include additional ingredients that, if present, would affect the composition. The term “consisting essentially of” may also refer to a component of the composition.

The term “substantially free” of a particular substance means that the compositions of the instant specification contain less than 1.0 wt. % of the recited substance. When referring to “substantially free” it is intended that the substance is not intentionally added to the compositions. The term “essentially free” of a particular substance means that the compositions of the instant specification contain less than 0.5 wt. % of the recited substance. When referring to “essentially free” it is intended that the substance is not intentionally added to the compositions. The term “essentially completely free” of a particular substance means that the compositions of the instant specification contain less than 0.01 wt. % of the recited substance. When referring to “essentially completely free” it is intended that the substance is not intentionally added to the compositions. The term “completely free” of a particular substance means that the compositions of the instant specification contain less than 0.001 wt. % of the recited substance. When referring to “completely free” it is intended that the substance is not intentionally added to the compositions. Use of the term “completely free” allows for trace amounts of that substance to be included in compositions because they are present in another substance in the composition. However, it is recognized that only trace or de minimus amounts of a substance will be allowed when the composition is said to be “completely free” of that substance.

In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 supports claims to any of the following ranges: 1-5; 1-4; 1-3; 1-2; 2-5; 2-4; 2-3; 3-5; 3-4; and 4-5.

### DETAILED DESCRIPTION

In recent years there has been strong consumer demand for the development of more nutritious pet chews. As discussed above, pet chews have been traditionally been made of rawhide which has limited nutritional value. More recently, the use of rice and wheat proteins in pet chews has been explored. However, these formulations tend to have higher caloric values in relation to the improved nutritional value. Therefore there remains a need for the development of a low calorie, yet highly nutritious pet chew that are made without rawhide.

An edible pet chew with a hardened and chewable outer wrap or casing made from a plant-based material instead of rawhide, one avoids all the concerns whether real or perceived regarding the use of rawhide. Secondly, the plant-based material has inherent nutrition and may be easily provided with added nutritional ingredients such as vitamins and minerals if desired.

In accordance with other aspects of the present disclosure, a pet's body naturally contains many antioxidants that work together, in a variety of ways to help protect and insure health. Antioxidants, found in many natural sources can increase the life span and slow the aging process by providing the body with additional defenses against free radicals and decreasing the resultant levels of oxidative damage.

In some preferred embodiments the present disclosure provides an elegant solution by incorporating proteins derived from alternative grains. Alternative grains such as amaranth, arrowroot, buckwheat, corn and cornmeal, flax, gluten-free flours (rice, soy, corn, potato, bean), hominy (corn), millet, quinoa, brown rice, sorghum, soy, tapioca (cassava root), teff, barley, farro, spelt, pyslium husk, chickpeas, lima beans, squash, parsnips, and oats offer impressive nutritional profiles, including a high doses of fiber and protein without significantly increasing the caloric value of the pet chew. The incorporation of these grains also can provide satiating nutrients that enhance mood, increase energy-levels and aid in weight loss and maintenance. Thus the use of proteins derived from these alternative grains provides a low calorie, highly nutritious pet chew. Accordingly, some of the embodiments of the present disclosure are substantially free from rawhide. In other embodiments the pet chews of the present disclosure are completely free of rawhide.

In addition to their increased nutritional profiles, embodiments of the present disclosure may also be gluten-free. Gluten is a mixture of two proteins, gliadin and glutenin, which is found in many grains such as wheat, barley, rye, and couscous. Gluten is digested in the small intestine by pancreatic enzymes. When an animal suffers from gluten sensitivity, the presence of gluten in the diet causes an inflammatory response in the small intestine. Intestinal inflammation has several consequences, including: the atrophy of the villi in the lining of the small intestine responsible for the absorption nutrients from food; and an increase in the numbers of lymphocytes present in the intestine. This damage to the intestine can make it harder for nutrients to be absorbed, eventually leading to malnutrition and weight loss. More unpleasant gastrointestinal symptoms may also occur, such as diarrhea and vomiting. Other signs like skin conditions are possible, depending on the severity of the allergy. While a gluten-free diet is not essential for animals, studies have shown that animals with sensitivity to gluten may benefit significantly from gluten-free diets. Several of the alternative grains utilized in embodiments of the present disclosure are gluten-free. For instance, amaranth, buckwheat, corn, hato mugi, millet, montina, quinoa, rice, sorghum, teff, wild rice, and certain varieties of oats are all gluten-free. Accordingly, some embodiments of the present disclosure of substantially free of gluten. In other embodiments the pet chew of the present disclosure are completely free of gluten.

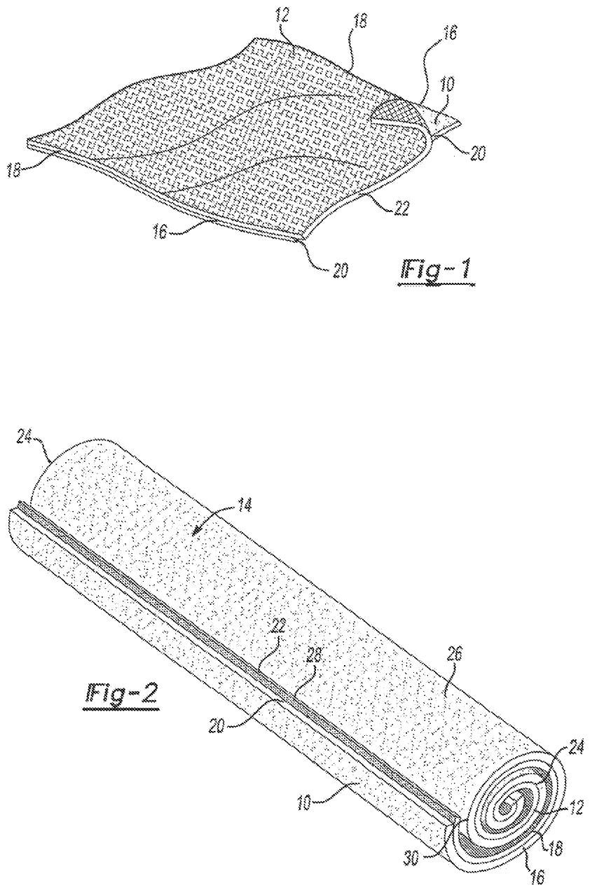

In some embodiments of the present disclosure the pet chew comprises of a first sheet 10 and a second sheet 12 combined together. Referring now to FIG. 1, the first sheet 10 of an extruded or rolled alternative grain-based composition, for example a quinoa protein mixed with a gelatin or other binder, for example glycerin, is laid flat. The term “grain-based” means material having substantially over 50% of grain material selected from alterative grain sources such as amaranth, arrowroot, buckwheat, corn and cornmeal, flax, gluten-free flours (rice, soy, corn, potato, bean), hominy (corn), millet, quinoa, brown rice, sorghum, soy, tapioca (cassava root), teff, barley, farro, spelt, pyslium husk, chickpeas, lima beans, squash, parsnips, oats and combinations thereof. In some embodiments first sheet 10 includes a grain-based protein preferably substantially free of rice and wheat, or gluten. The percentage of grain-based protein powder in first sheet 10 by weight, is preferably at least 50%, at least 40%, at least 30% by weight. In some embodiments first sheet 10 has a percentage of grain-based protein powder between 20 and 30%, most preferably around 25%. Such percentages have been found to permit good chewability and durability for the outer layer, especially when used with animal based products that are 50% or more of the outer layer.

The gelatin present in first sheet 10 may be a small percentage by weight, for example 5%, to provide sufficient malleability, moldability, extrudability, and formability. In preferred embodiments gelatin is present in first sheet 10 in less than 10 wt.-%. For example in some embodiments beef gelatin may be present in the amount of about 6 wt.-% to 7 wt.-%. In other embodiments carboxylmethylcellulose, may be added in the amount of 1 wt.-% to 3 wt.-% to the first sheet 10.

First sheet 10 may also include other auxiliary ingredients including plant material selected from a group consisting of apple, apricot, banana, blackberry, blackcurrant, blueberry, coconut, cherry, cherimoya, date, durian, fig, feijoa, gooseberry, grape, grapefruit, jackfruit, jambul, kiwifruit, kumquat, lemon, lime, loquat, lychee, mango, mangosteen, melon, cantaloupe, honeydew, watermelon, nectarine, orange, passionfruit, peach, pear, plum, prune, pineapple, pomegranate, pommelo, raspberry, rambutan, redcurrant, satsuma, strawberry, tangerine, ugli fruit, artichoke, asparagus, avocado, bamboo shoots, bean sprouts, beans, beet, endive, bell pepper, broccoli, brussels sprouts, cabbage, calabaza, carrot, cauliflower, celery, cucumber, radish, eggplant, garlic, fiddlehead, galangal, ginger, beet greens, collard greens, dandelion greens, kale, mustard, spinach, Swiss chard, turnip greens, Jerusalem artichoke, jicama, lettuce, mushrooms, okra, onion, parsley, peas, peppers, plantain, pumpkin, radicchio, radish, rutabaga, spinach, sweet potato, tomato, turnip, water chestnut, yams, and combinations thereof.

In other embodiments, first sheet 10 may also include other auxiliary ingredients including, a binding agent, a moisturizing compound, a salt, a sugar, an acid, a mold inhibitor, a flavoring compound, an aroma compound, a coloring compound and any combination of two or more thereof. In still yet other embodiments first sheet 10 can include other auxiliary ingredients including, a health ingredient selected from the group consisting of glucosamine, chondroitin, flax seed, calcium, parsley seed, peppermint, chlorophyll, vitamin E, L-carnitine, and lycopene, and mixtures thereof.

In other embodiments the grain materials of first sheet 10 may be substituted for the above mentioned materials as long as the material is a cohesive material that can be rolled and formed in a malleable state and eventually hardened by heat or drying into a hard but chewable matter for use by a carnivorous animal. First sheet 10 may be formed by the non-limiting process such as extrusion, pressing or rolling or injection molding.

A second sheet 12 may be made from flavored material, for example, natural meat jerky. In some embodiments second sheet 12 comprises of a meat selected from a group consisting of pork, beef, chicken, duck, goat, horse, buffalo, venison, elk, moose, liver, fish, veal, lamb, turkey, goose and combinations thereof. In preferred embodiments second sheet 12 comprises of chicken breast jerky. In some embodiments second sheet 12 preferably constitutes 5 to 10% of the total weight of the pet-chew 1, and most preferably about 7 percent. In another variation, the second sheet 12 may also be made from an initially malleable grain-based sheet that is impregnated with meat, chicken, fish or jerky pieces or merely infused with flavors attractive to a pet.

Second sheet 12 is superimposed over the first sheet 10. The second sheet 12 may alternately be made from a jerky composition that is a mixture of meat and other binders to form a chewable composite that is malleable enough to be rollable. The side edges 18 of the second sheet may be coextensive, i.e. aligned with the side edges 16 of the first sheet 10. The front edge 22 of the second sheet may overlap the front edge 20 of sheet 10.

Once the first and second sheets 10 and 12 as shown in FIG. 1, are flattened out, they are then rolled up as shown in FIG. 2 to form a cylinder shaped edible pet chew 14 having rolled ends 24 with interleaved layers of sheet 10 and sheet 12 with aligned edges 16 and 18. The sheets 10 and 12 form an interleaved spiral shape in cross-section. The sheets 10 and 12 are rolled such that the sheet 10 forms the outer layer 26. The front edge 22 of sheet 12 by extending further than the front edge of edge 20 of sheet 10 forms a lip 28. The lips 28 project out of the seam 30 in the outer layer 26 adjacent the edge 20 of sheet 10. The cylinder shaped pet chew 14 is then allowed to dry to harden.

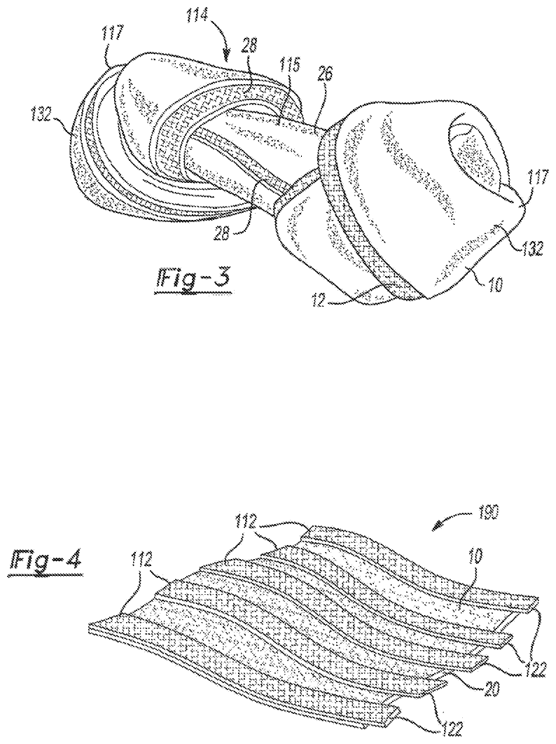

As shown in FIG. 3, an alternate shaped pet chew 114 can be formed to more closely simulate an elongated bone with an elongated middle section 115 also referred to as a diaphysis and opposite simulated epiphyses 117 formed by knots 132 tied at each end 24 of the cylinder shaped assembly 14 as shown in FIG. 2 before it's hardened. The alternately shaped edible pet chew 114 still has the same aligned edges 16, and 18 and the same lip 28 of the second sheet protruding out of seam 30 at the epiphyses 117 as well as there between is elongated middle section 115.

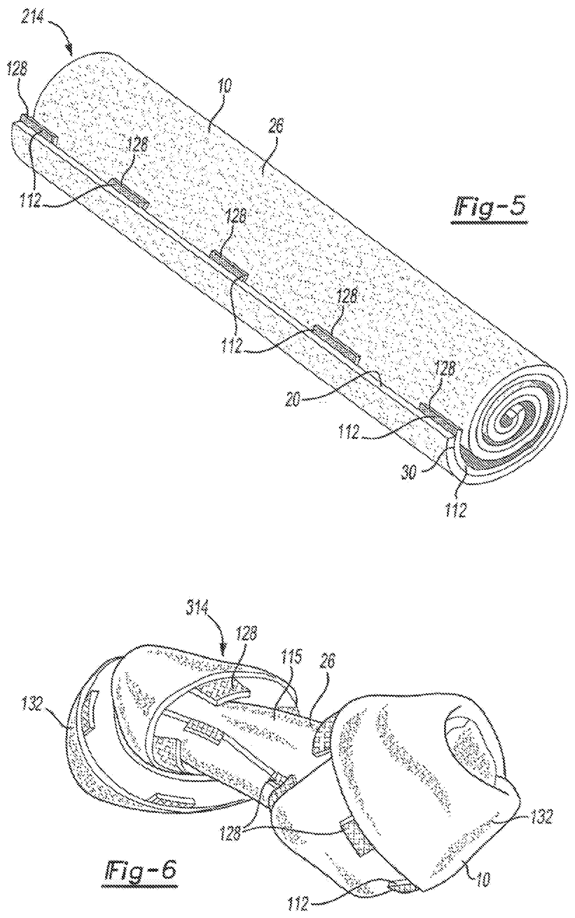

Another alternate embodiment composite sheet assembly 190 is shown in FIG. 4 where instead of single sheet of jerky material is disposed on sheet 10, a plurality of elongated strips of jerky i.e. narrow sheets 112 are spaced apart onto sheet 10. The narrow sheets 112 each have a front edge 122 extending beyond edge 20 of sheet 10. The sheet assembly 190 is laid flat and then rolled in the same fashion as before to form the cylinder assembly 214 shown in FIG. 5 that has at seam 30 a plurality of exposed lips 128 of the sheets 112. Again, this cylinder shape treat 214 may be dried and hardened as is or can be knotted in the same fashion as before to form the bone shaped pet treat 314 as shown in FIG. 6 with the exposed lips 128 formed in the knot ends 132 as well as the elongated middle section 115.

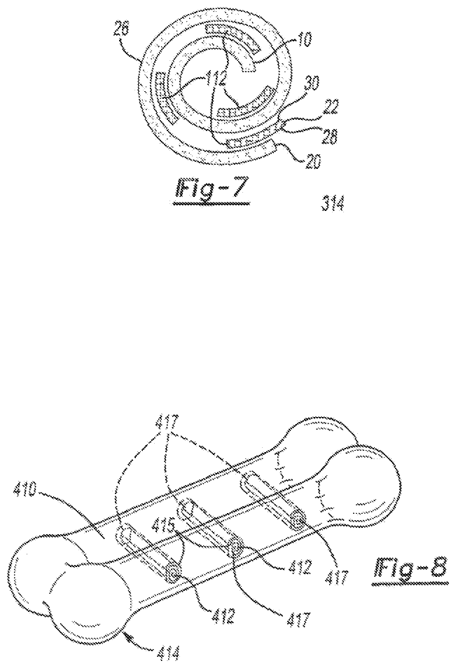

In a further embodiment, the elongated strips 112 may be laid transverse to what is shown in FIG. 4 so that when the sheets 110 and 112 are rolled, they produce an edible pet chew with an end 432 as shown in FIG. 7 with a solid lip 28 and a plurality of spaced sheets 112 within the outer layer 26 of sheet 10. Again, the cylinder may be allowed to dry and harden in this position or tied into a knot to form an edible pet chew that looks on the exterior substantially like the one shown in FIG. 3.

It is foreseen that more than one first sheet 10 of the grain-based material and more than second sheet 12 of the flavor material may be used. It is also foreseen that the plurality of sheets 10, 12 may be interlayered without rolling to form a flat rectangular or other shaped edible pet chew. The composite pet chew may also be folded into another shaped pet chew.

Referring now to FIG. 8, a pet chew 414 has a three dimensional molded outer casing 410 of grain-based material has an elongated bone-like shape and having cavities 415 traversing the longitudinal axis of the outer casing 412. Jerky material or other dried or cured animal flesh 412 is inserted into the cavities 415. The outer casing 410 may be injected molded with the cavities 415 formed therein. Preferably, the exposed ends 417 of the jerky 412 is flush or slightly recessed in cavities 415 and the jerky is tightly packed in hole 415 to deter the jerky from being easily pulled out of the hole 415 such that the dog will chew through the outer shell 410 to access the jerky 412.

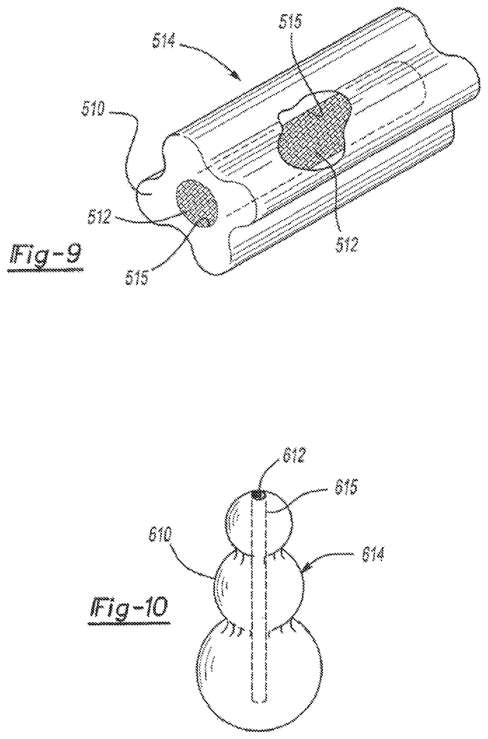

Another molded form is shown in FIG. 9 where the pet chew 514 has the molded outer shell 510 of grain-based material with a longitudinal extending cavity 515 filler with jerky material 512. The molded cavity 510 may have a clover leaf cross-sectional configuration as shown.

In a modified embodiment shown in FIG. 10, the outer casing 610 of grain-based material may have a three ball configuration surrounding longitudinal cavity 615 filled with jerky 612.

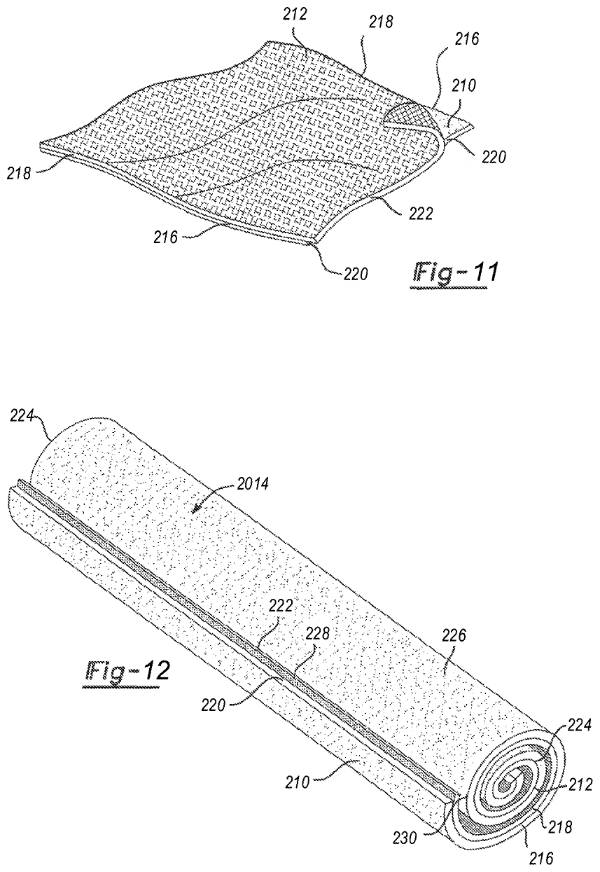

Referring now to FIG. 11, a first layer 210 of an extruded or rolled plant based composition, for example a wheat protein mixed with a gelatin or other binder for example glycerin is laid flat. The term “plant based” means material having substantially over 50% of plant material. The gelatin may be a small percentage by weight, for example 5%, to provide sufficient malleability, moldability, extrudability, and formability as set forth in further detail below. Other plant materials may be substituted for the above mentioned materials as long as the material is a cohesive material that can be rolled and formed in a malleable state and eventually hardened by heat or drying into a hard but chewable matter for use by a carnivorous pet. The sheet 210 may be formed by extrusion, pressing or rolling or injection molding for example.

A second layer 212 may be made from flavored material, for example, a natural vegetable or fruit mixture, collectively called a plant mixture. The sheet 212 is superimposed over the first layer 210. The second layer 212 may alternately be made from a vegetable and/or fruit composition that is a mixture of vegetable and other binders and auxiliary ingredients to form a chewable composite that is malleable enough to be rollable, In another variation, the second layer 212 may also be made from an initially malleable plant based sheet that is impregnated with vegetables, fruits or merely infused with flavors attractive to a pet.

The side edges 218 of the second layer may be coextensive, i.e. aligned with the side edges 216 of the first layer 210. The front edge 222 of the second layer may overlap the front edge 220 of sheet 210.

Referring now to the plant based material that can be included as part of the first layer or second layer. The plant base is made from a plant base material, such as a fruit, vegetable, vegetable protein, fruit extract, vegetable extract and combinations thereof that can be consumed by a domestic pet. The plant material may be fresh, dehydrated, powdered, an extract or frozen.

In one example embodiment, the plant base does not include any meat product, such as beef, pork, lamb, goat, horse, buffalo, venison, elk, moose, bone-in chicken, turkey, fish, or any other seafood. The term “meat” as described herein is intended to encompass portions of animals, mammal and non-mammal, that can be used for a pet chew. This includes but is not limited to soft tissue, internal organs, cartilage and bone.

A plant base material, as used herein, means a fruit, vegetable, vegetable protein, fruit extract, and/or vegetable extract that can be consumed by a domestic pet, such as a dog. The plant based material may be produced in various sizes or shapes. In particular, following mixture, the textured vegetable protein may be cut or shaped to desired dimensions.

In one embodiment of the invention, the plant base may include fruits such as, apple, apricot, banana, blackberry, blackcurrant, blueberry, coconut, cherry, cherimoya, date, durian, fig, feijoa, gooseberry, grape, grapefruit, jackfruit, jambul, kiwifruit, kumquat, lemon, lime, loquat, lychee, mango, mangosteen, melon, cantaloupe, honeydew, watermelon, nectarine, orange, passionfruit, peach, pear, plum, prune, pineapple, pomegranate, pommelo, raspberry, rambutan, redcurrant, satsuma, strawberry, tangerine, ugli fruit and combinations thereof.

The plant base may include vegetables such as, artichoke, asparagus, avocado, bamboo shoots, bean sprouts, beans, beet, endive, bell pepper, broccoli, brussels sprouts, cabbage, calabaza, carrot, cauliflower, celery, cucumber, radish, eggplant, garlic, fiddlehead, galangal, ginger, beet greens, collard greens, dandelion greens, kale, mustard, spinach, Swiss chard, turnip greens, Jerusalem artichoke, jicama, lettuce, mushrooms, okra, onion, parsley, parsnip, peas, peppers, plantain, pumpkin, radicchio, radish, rutabaga, spinach, squash, sweet potato, tomato, turnip, water chestnut, yams, and combinations thereof.

Pet chew may also include a starch composition which comprises any carbohydrate of natural or vegetable origin. The starch may include amylose and/or amylopectin and may be extracted from plants, including but not limited to potatoes, rice, tapioca, corn and cereals such as rye, wheat, and oats. The starch may also be extracted from fruits, nuts and rhizomes, or arrowroot, guar gum, locust bean, arracacha, buckwheat, banana, barley, cassava, konjac, kudzu, oca, sago, sorghum, sweet potato, taro, yams, fava beans, lentils and peas. The starch may be present between about 6-80% including but not limited to 10%, 15%, 20%, 25%, 30%, 35%, 40%, 45%, 50%, 55%, 60%, 65%, 70%, 75% and 80%. Alternatively, the starch composition may be at least 10%, 15%, 20%, 25%, 30%, 35%, 40%, 45%, 50%, 55%, 60%, 65%, 70%, 75% or 80%.

In some embodiments, starch is used to provide structural support to the plant mixture. The starch employed herein may be raw starch, which may be understood as starch that has not seen a prior thermal molding history, such as extrusion or other type of melt processing step. The raw starch itself may also be native, which may be understood as unmodified starch recovered in the original form by extraction and not physically or chemically modified. The raw starch may also be in powder form of varying particle size, which may be understood as milled and/or pre-sifted. It should be understood that the raw starch may also have varying degrees moisture present. The starch composition may include cellulose. The cellulose may be, for example, a long-chain polymer of polysaccharide carbohydrate. The cellulose may also be derived or extracted from plants. The cellulose may be incorporated into the starch composition between about 1-10% by weight of the starch composition.

Additionally, herbs, herbal extracts, vitamins, minerals, yeast products, soy products, may be incorporated into the plant base. Further, the plant base may also include food sources that provide phytochemicals. A non-exclusive list phytochemicals include: carotenoids, lycopenes, beta cryptozanthin, flavonoids, indoles, sulforaphane, isoflavones, allicin, genistein, polyphenols, anthocyanins, limonoids, sterols, capsaicin, elegiac acid and lignans. In alternative embodiments, the pet chew does not include soy.

In one example embodiment, carotenoids are included in the plant base. In at least this example embodiment the carotenoids are included from a plant selected from a group consisting of carrots, cantaloupe, papaya, pumpkin, squash, sweet potatoes, broccoli, dried apricots, asparagus, kale, green leafy vegetables and combinations thereof. In related embodiments lycopenes are included in the plant base. The lycopenes are added with the addition of plants selected from a group consisting of tomatoes, tomato paste, tomato juice, guava, pink grapefruit, watermelon and combinations thereof. In other related embodiments, beta cryptozanthin are included in the plant base. Beta cryptozanthin are found in plants such as tangerines, papaya, oranges, peaches, mangoes, nectarines and combinations thereof.

In other example embodiments flavonoids extracted from plants such as soy, green tea, tomatoes, sweet potatoes, cruciferous vegetables such as broccoli, cabbage, brussels sprouts, mustard greens, kale, and cauliflower, citrus fruits, onions and combinations thereof can be used in the plant base. In other example embodiments, indoles and sulforaphane, which are commonly found in cruciferous vegetables are added to plant base. Examples of cruciferous vegetables include, but are not limited to cauliflower, cabbage, garden cress, bok choy, broccoli and brussels sprouts. In other related embodiments, isoflavones are included in plant base. Isoflavones are commonly found in legumes, such as beans, peas and lentils and soy products. In other related embodiments, allicin is added to the plant base, which can be found in plants such as onions and garlic. In example embodiments genistein is added through the addition of products, such as tofu. In other example embodiments, polyphenols can be added through the addition of green tea.

In yet other related embodiments, anthocyanins found in plants such as wild blueberries, bilberries and black berries can be included in plant base. Limonoids, found in citrus fruits such as clementine, grapefruit, kumquat, lemon, lime, mandarin, orange, tangerine and the like can also be added to plant base. In other embodiments, sterols from cruciferous vegetables, cucumbers, squash, sweet potatoes, soy foods, eggplant, whole grains, tomatoes and the like are included in plant base. In embodiments where the addition of capsaicin is desired, the phytochemical can be added by including chili peppers. Similarly, in embodiments where elegiac acid is desired strawberries, for example, can be included in the plant base. The addition of lignans, can be achieved by the addition of nuts and seeds. It should be appreciated that the addition of certain plants will include more than one phytochemical listed herein. Further, extract(s) of the aforementioned plants can be added to specifically add a desired phytochemical or combination of phytochemicals to the plant base.

Other sources of important nutrients for animals may also include seaweed, kelp, blue green algae, spirulina, Irish moss, dulse, nori, kombu, wakeme, alfalfa, fenugreel seed, wheatgrass, barleygrass and marine phytoplankton.

The plant material is used in an amount of about 6% to 90% of the plant mixture. In one example embodiment, the plant material is used in an amount of about 6-35% by weight of the plant mixture. In other related embodiments, the plant material makes up between 6% and 90% of the total weight of the pet chew. It should be appreciated that the other plant sources, including various extracts, can be used to provide a final taste or consistency for the plant mixture. In embodiments where other plant sources are used, the total plant content is 6% to 95% by weight of the entire plant mixture.

The plant mixture is prepared by mixing the plant base with auxiliary ingredients that may include a binding agent, a salt, a sugar, an acid, a mold inhibitor, a flavoring, an aroma compound, a coloring compound, or any combination of two or more thereof. It is important to note that the plant mixture, can be used in total or in part in both the first layer and/or second layer.

The binding agent can be used in an amount between about 10% and about 75% by weight of the plant mixture. In one example embodiment the binding agent is about 20% by weight of the plant mixture. For example, the binding agent can be added to “buffer” or to absorb fat content in the plant mixture. The binding agent can also facilitate the blending of the various ingredients and allow the plant mixture to hold a shape prior to being dried.

The binding agent can include, but is not limited to; oat flour, soy flour, wheat flour, rice flour, potato flour, corn flour, rye flour, buckwheat flour, chestnut flour, chickpea flour, atta flour, pea flour, bean flour, amaranth flour, arrowroot flour, taro flour, cattail flour, acorn flour, sorghum flour, or tapioca flour, or a combination of two or more thereof. The flour, in this case wheat flour, is incorporated in amount of no more than 25% by weight of the plant mixture.

The aroma compound or flavoring compound, provide palatability enhancement respectively and include, but are not limited to, garlic (e.g., garlic concentrate, garlic oil, garlic powder, garlic aroma), onion (e.g., onion concentrate, onion oil, onion powder, onion aroma), natural smoke flavor, hickory, mesquite, tikka, tandoori, parsley, spinach, saffron, cheese, peanut butter, almond butter, or any derivative thereof, or any combination of two or more thereof. Additionally salt may be added to enhance flavor and can also provide particle binding in forming plant mixture.

The aroma compound or flavoring compound can be used in an amount between about 0% and about 5% by weight of the plant mixture, for example less than about 1% by weight of the plant mixture. The coloring compound can be used in an amount between about 0% and about 4% by weight of the plant mixture, for example less than about 1% by weight of the plant mixture. Flavoring compounds can be used in an amount between about 0% and about 0.5% by weight of the plant mixture, for example about 0.25% by weight of the plant mixture.

Coloring compounds provide cosmetic enhancement respectively and include, but are not limited to, caramel coloring, malliouse, allura red AC, annatto, astaxanthin, betanin or beetroot red, blue 2, brilliant black BN, brilliant blue FCF, brown FK, canthaxanthin, carmine, carotene, Color Blue, curcumin, erythrosine, orange number 1, iron oxide, orange B, ponceau 6R, red 40, red 2G, saffron, sunset yellow FCF, tartrazine, titanium dioxide, turmeric, yellow 5, yellow 2, or any combination of two or more thereof. In some alternative embodiments that pet chew includes coloring compounds that are natural and do not contain artificial coloring agents. In other related embodiments, the pet chew is free of FD&C colors.

The humectant can be used to reduce water activity. Water activity is a measure of the availability of water in a food for microbial growth such as molds. Water activity is a primary method of controlling antimicrobial or mold growth. One example range of water activity is an aW value of less than 0.7. The humectant including sugar, or sugar alcohols can be used in an amount between about 0% and about 20% by weight of the plant mixture, for example about 15% to 18% by weight of the plant mixture. The humectant, can include, but is not limited to fructose, dextrose, maltodextrin, honey, high-fructose corn syrup, maltose, brown sugar, coconut sugar, date sugar, sucanat, molasses, turbinado sugar, dextrin, glucose, sucrose, sucralose, glycerin or any derivative thereof, or any combination of two or more thereof.

The plant mixture may also include a mold inhibitor. A non-exclusive list of mold inhibitors include, but is not limited to, potassium sorbate, cultured whey, calcium propionate, cultured dextrose, cultured yeast, benzoic acid, acetic acid, or plum powder, or any derivative thereof or any combination of two or more thereof.

A moisturizing compound can be used in a range of between 2% and 20%. For example, a moisturizing compound, such as water will aid in formation of the plant mixture. For example, the moisture content of the plant mixture may be above 20% prior to drying the pet chew, but will achieve a moisture content below 20%, for example 18%, in the final pet chew product.

It should be appreciated that each of these ingredients other than the plant base is optional, such as the ingredients with a percentage range starting at 0%. After mixing the plant base with the auxiliary ingredients the plant mixture is further processed to facilitate the formation of the plant mixture.

In example embodiments, pet chews include various combinations of ingredients that are both palatable to the pet and appeal to the consumer. Some non-limiting examples of pet chew combinations within the scope of the invention include, banana and peanut butter; spinach and cheese; and pumpkin and oats. It should be appreciated that these combinations could be included in the form of the actual food product or flavoring that mimics each of the food product tastes for each of the specific flavors.

In other alternative embodiments, the pet chew is free, or substantially free, from gluten, soy, artificial flavors and rawhide. As described here, substantially free includes amounts of particular ingredients less than 1% by weight of the final pet chew product.

Once the first and second layers 210 and 212 as shown in FIG. 11, are flattened out, they are then rolled up as shown in FIG. 12 to form a cylinder shaped edible pet chew 2014 having rolled ends 224 with interleafed layers of sheet 210 and sheet 212 with aligned edges 216 and 218. The sheets 210 and 212 form an interleaved spiral shape in cross-section. The sheets 210 and 212 are rolled such that the sheet 210 forms the outer layer 226. The front edge 222 of sheet 212 by extending further than the front edge of edge 220 of sheet 210 forms a lip 228. The lips 228 project out of the seam 230 in the outer layer 226 adjacent the edge 220 of sheet 210. The cylinder shaped pet chew 2014 is then allowed to dry to harden the composition forming the first layer 210.

As shown in FIG. 13, an alternate shaped pet chew 2114 can be formed to more closely simulate an elongated bone with an elongated middle section 2115 also referred to as a diaphysis and opposite simulated epiphyses 2117 formed by knots 2132 tied at each end 224 of the cylinder shaped assembly 214 as shown in FIG. 12 before pet chew is hardened. The alternately shaped edible pet chew 2114 still has the same aligned edges 216, and 218 and the same lip 228 of the second layer protruding out of seam 230 at the epiphyses 2117 as well as there between is elongated middle section 2115.

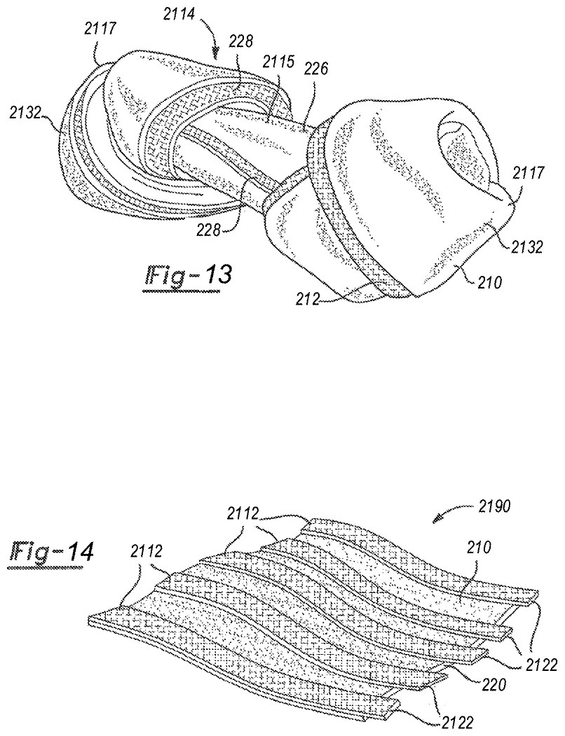

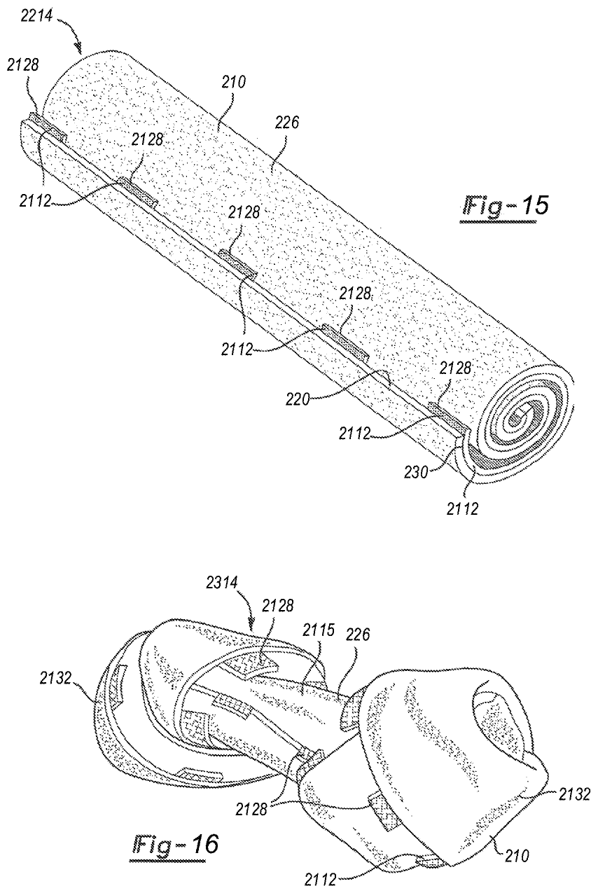

Another alternate embodiment composite sheet assembly 2190 is shown in FIG. 14 where instead of single sheet of vegetable and/or fruit material is disposed on sheet 210, a plurality of elongated strips of vegetable and/or fruit strips (i.e. narrow sheets 2112 are spaced apart onto sheet 210. The narrow sheets 2112 each have a front edge 2122 extending beyond edge 220 of sheet 210. The sheet assembly 2190 is laid flat and then rolled in the same fashion as before to form the cylinder assembly 2214 shown in FIG. 15 that has at seam 230 a plurality of exposed lips 2128 of the sheets 2112. Again, this cylinder shape treat 2214 may be dried and hardened as is or can be knotted in the same fashion as before to form the bone shaped pet chew 2314 as shown in FIG. 16 with the exposed lips 2128 formed in the knot ends 2132 as well as the elongated middle section 2115.

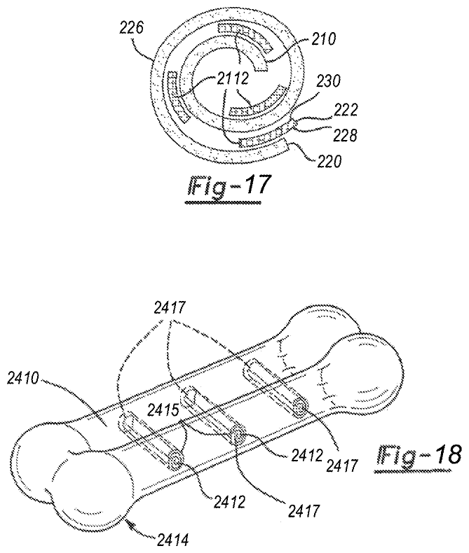

In a further embodiment, the elongated strips 2112 may be laid transverse to what is shown in FIG. 14 so that when the sheets 2110 and 2112 are rolled, they produce an edible pet chew with an end 2432 as shown in FIG. 17 with a solid lip 228 and a plurality of spaced sheets 2112 within the outer layer 226 of sheet 210. Again, the cylinder may be allowed to dry and harden in this position or tied into a knot to form an edible pet chew that looks on the exterior substantially like the one shown in FIG. 13.

It is foreseen that more than one first layer 210 of the plant based material and more than one sheet 212 of the flavor material may be used. It is also foreseen, that the plurality of sheets 210, 212 may be interlayered without rolling to form a flat rectangular or other shaped edible pet chew, such as pet chips. The composite pet chew may also be folded into another shaped pet chew.

Referring now to FIG. 18, a pet chew 2414 has a three dimensional molded outer casing 2410 of plant based material has an elongated bone-like shape and having cavities 2415 traversing the longitudinal axis of the outer casing 2412. Vegetable and/or fruit material or other dried or cured animal flesh 2412 is inserted into the cavities 2415. The outer casing 2410 may be injected molded with the cavities 2415 formed therein. In one embodiment, the exposed ends 2417 of the vegetable and/or fruit 2412 is flush or slightly recessed in cavities 2415 and the vegetable and/or fruit is tightly packed in hole 2415 to deter the vegetable and/or fruit from being easily pulled out of the hole 2415 such that the dog will chew through the outer shell 2410 to access the vegetable and/or fruit 2412.

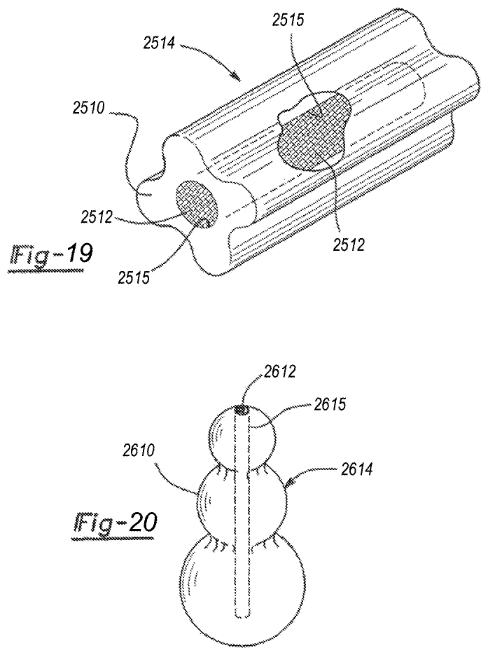

Another molded form is shown in FIG. 19 where the pet chew 2514 has the molded outer shell 2510 of plant-based material with a longitudinal extending cavity 2515 filler with vegetable and/or fruit material 2512. The molded cavity 2510 may have a cloverleaf cross-sectional configuration as shown.

In a modified embodiment shown in FIG. 20, the outer casing 2610 of plant-based material may have a three ball configuration surrounding longitudinal cavity 2615 filled with vegetable and/or fruit 2612.

In this fashion, by providing an edible pet chew with a hardened and chewable outer wrap or casing made from a plant-based material instead of rawhide, one avoids all the concerns whether real or perceived regarding the use of rawhide. Secondly, the plant-based material has inherent nutrition and may be easily provided with added nutritional ingredients such as vitamins and minerals if desired.

Furthermore, the second layer or insert, whether it will be a natural vegetable and/or fruit, vegetable and/or fruit composite, vegetable and/or fruit composite flavoring agent or plant based layer with flavor, provides a taste incentive for the pet to continue to chew and not lose interest in the pet chew after only a short period of time.

A pet's body naturally contains many antioxidants that work together, in a variety of ways to help protect and insure health. Antioxidant neutralize harmful compounds called free radicals. Exposure to the sun's ultraviolet rays, environmental toxins, pollution, heavy metals, stress, diet and drugs, including antibiotics, contribute to the production of free-radicals. Free-radicals cause oxidative stress, which damages cells and can also adversely affect vital tissues, organs and even DNA. Oxidative damage has been associated with many of the leading age related degenerative diseases including cancer, heart disease, liver and kidney disorders as well as arthritis, diabetes, senility, cognitive dysfunction and canine Alzheimer's disease.

Accordingly, the harmful effects of free radicals accumulate and have been proven to decrease the quality and length of life. However, it has been found that antioxidants, found in many natural sources can increase the life span and slow the aging process by providing the body with additional defenses against free radicals and decreasing the resultant levels of oxidative damage.

In some preferred embodiments of the present disclosure pet chews are supplemented with an anti-oxidant rich based material and therefore are capable of addressing oxidative stress caused by free radicals. Preferred anti-oxidant rich based materials include: acai berries, blueberries, blackberries, spinach, brown rice, quinoa, chia seeds, flax seeds, wheat grass, pumpkin, salmon, kiwi, asparagus and combinations thereof. These anti-oxidant rich plant based materials are incorporated in the flavor layer of the pet chews. In some preferred embodiments that anti-oxidant rich plant material is incorporated in a meat layer.

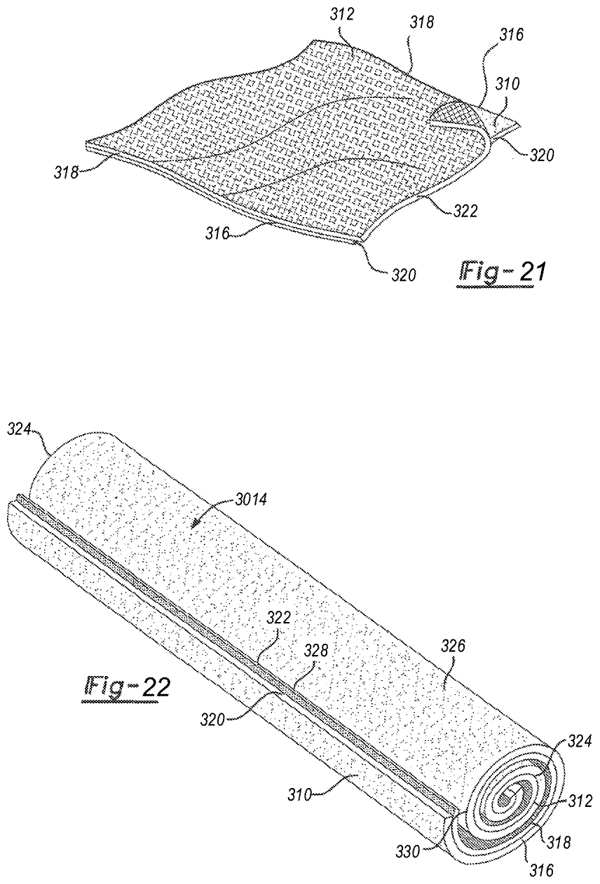

Referring now to FIG. 21, a first sheet 310 of an extruded or rolled plant based composition, for example a wheat protein mixed with a gelatin or other binder for example glycerin is laid flat. The term “plant based” means material having substantially over 50% of plant material. The gelatin may be a small percentage by weight, for example 5%, to provide sufficient malleability, moldability, extrudability, and formability as set forth in further detail below. Other plant materials may be substituted for the above mentioned materials as long as the material is a cohesive material that can be rolled and formed in a malleable state and eventually hardened by heat or drying into a hard but chewable matter for use by a carnivorous pet. The sheet 10 may be formed by extrusion, pressing or rolling or injection molding for example.

A second sheet 312 may be made from flavored material, for example, natural meat jerky. In some embodiments second sheet 312 comprises of a meat selected from a group consisting of pork, beef, chicken, duck, goat, horse, buffalo, venison, elk, moose, liver, fish, veal, lamb, turkey, goose and combinations thereof. In preferred embodiments second sheet 312 comprises of chicken breast jerky. In another embodiment, the second sheet 312 may also contain an anti-oxidant rich based material combined with meat, chicken, fish or jerky pieces or merely infused with flavors attractive to a pet. Preferred anti-oxidant rich based materials include: acai berries, blueberries, blackberries, spinach, brown rice, quinoa, chia seeds, flax seeds, wheat grass, pumpkin, salmon, kiwi, and asparagus. These anti-oxidant rich based materials are incorporated in the meat flavor layer of the pet chews. In some embodiments, the anti-oxidant rich plant-based material preferably constitutes from about 5 wt.-% to about 10 wt.-% of second sheet 312. In some embodiments the anti-oxidant rich plant-based material preferably constitutes from about 4 wt.-%. In other embodiments the anti-oxidant rich plant-based material preferably less than about 4 wt.-%.

Second sheet 312 is superimposed over the first sheet 310. The second sheet 312 may alternately be made from a jerky composition that is a mixture of meat and other binders to form a chewable composite that is malleable enough to be rollable. The side edges 318 of the second sheet may be coextensive, i.e. aligned with the side edges 316 of the first sheet 310. The front edge 322 of the second sheet may overlap the front edge 320 of sheet 310. In some embodiments second sheet 312 preferably constitutes from about 5 wt.-% to about 10 wt.-% of the total weight of the pet-chew 314, and most preferably about 7 wt.-%.

In alternative embodiments, the second sheet comprise a cheese or cheese product. In other alternative embodiments, the second sheet comprises a Greek yogurt. In yet other preferred embodiments the pet chew comprises combination of ingredients, including but not limited to spinach, quinoa and cheese; turkey and pumpkin; and chicken and Greek yogurt.

Once the first and second sheets 310 and 312 as shown in FIG. 21, are flattened out, they are then rolled up as shown in FIG. 22 to form a cylinder shaped edible pet chew 3014 having rolled ends 324 with interleaved layers of sheet 310 and sheet 312 with aligned edges 316 and 318. The sheets 310 and 312 form an interleaved spiral shape in cross-section. The sheets 310 and 312 are rolled such that the sheet 310 forms the outer layer 326. The front edge 322 of sheet 312 by extending further than the front edge of edge 320 of sheet 310 forms a lip 328. The lips 328 project out of the seam 330 in the outer layer 326 adjacent the edge 320 of sheet 310. The cylinder shaped pet chew 314 is then allowed to dry to harden.

As shown in FIG. 23, an alternate shaped pet chew 3114 can be formed to more closely simulate an elongated bone with an elongated middle section 3115 also referred to as a diaphysis and opposite simulated epiphyses 3117 formed by knots 3132 tied at each end 324 of the cylinder shaped assembly 314 as shown in FIG. 22 before it's hardened. The alternately shaped edible pet chew 3114 still has the same aligned edges 316, and 318 and the same lip 328 of the second sheet protruding out of seam 330 at the epiphyses 3117 as well as there between is elongated middle section 3115.

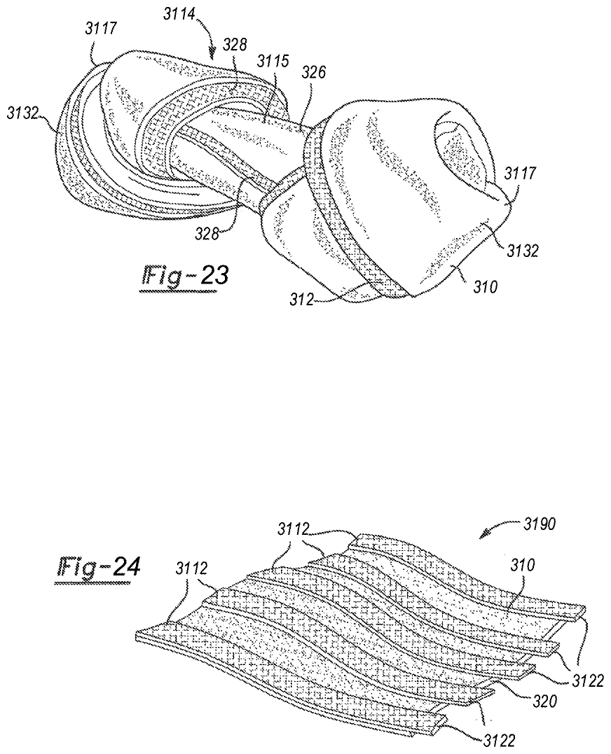

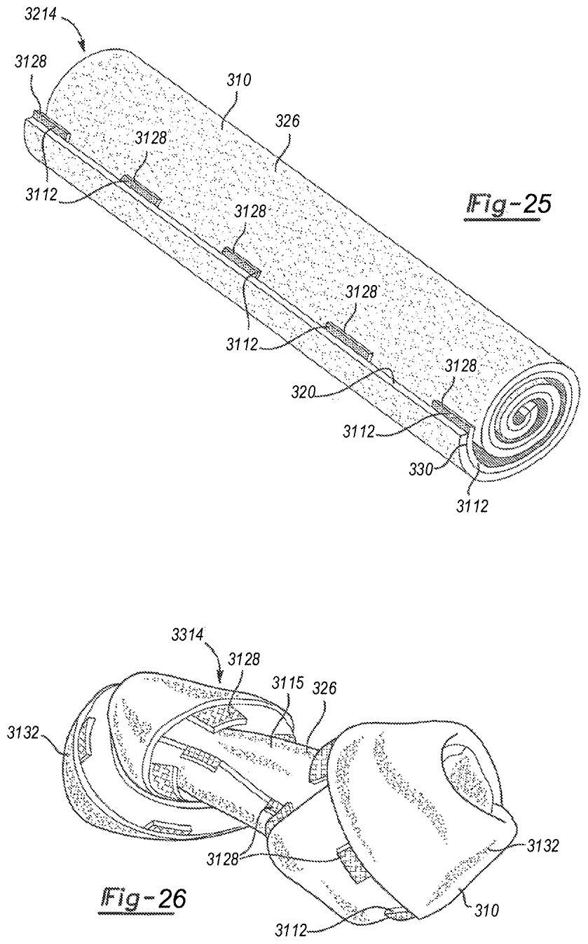

Another alternate embodiment composite sheet assembly 3190 is shown in FIG. 24 where instead of single sheet of anti-oxidant enhanced jerky material is disposed on sheet 310, a plurality of elongated strips of jerky i.e. narrow sheets 3112 are spaced apart onto sheet 310. The narrow sheets 3112 each have a front edge 3122 extending beyond edge 320 of sheet 310. The sheet assembly 3190 is laid flat and then rolled in the same fashion as before to form the cylinder assembly 3214 shown in FIG. 25 that has at seam 330 a plurality of exposed lips 3128 of the sheets 3112. Again, this cylinder shape treat 3214 may be dried and hardened as is or can be knotted in the same fashion as before to form the bone shaped pet treat 3314 as shown in FIG. 26 with the exposed lips 3128 formed in the knot ends 3132 as well as the elongated middle section 3115.

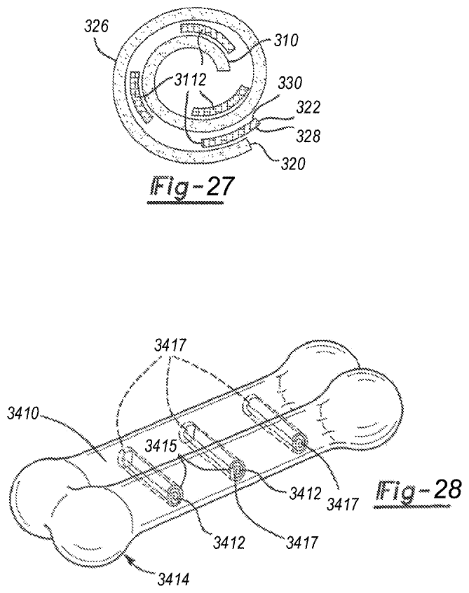

In a further embodiment, the elongated strips 3112 may be laid transverse to what is shown in FIG. 24 so that when the sheets 3110 and 3112 are rolled, they produce an edible pet chew with an end 3432 as shown in FIG. 27 with a solid lip 328 and a plurality of spaced sheets 3112 within the outer layer 326 of sheet 310. Again, the cylinder may be allowed to dry and harden in this position or tied into a knot to form an edible pet chew that looks on the exterior substantially like the one shown in FIG. 23.

It is foreseen that more than one first sheet 310 of the plant based material and more than second sheet 312 of the flavor material may be used. It is also foreseen that the plurality of sheets 310, 312 may be interlayered without rolling to form a flat rectangular or other shaped edible pet chew. The composite pet chew may also be folded into another shaped pet chew.

Referring now to FIG. 28, a pet chew 3414 has a three dimensional molded outer casing 3410 of plant based material has an elongated bone-like shape and having cavities 3415 traversing the longitudinal axis of the outer casing 3412. Jerky material or other dried or cured animal flesh 3412 is inserted into the cavities 3415. The outer casing 3410 may be injected molded with the cavities 3415 formed therein. Preferably, the exposed ends 3417 of the jerky 3412 is flush or slightly recessed in cavities 3415 and the jerky is tightly packed in hole 3415 to deter the jerky from being easily pulled out of the hole 3415 such that the dog will chew through the outer shell 3410 to access the jerky 3412.

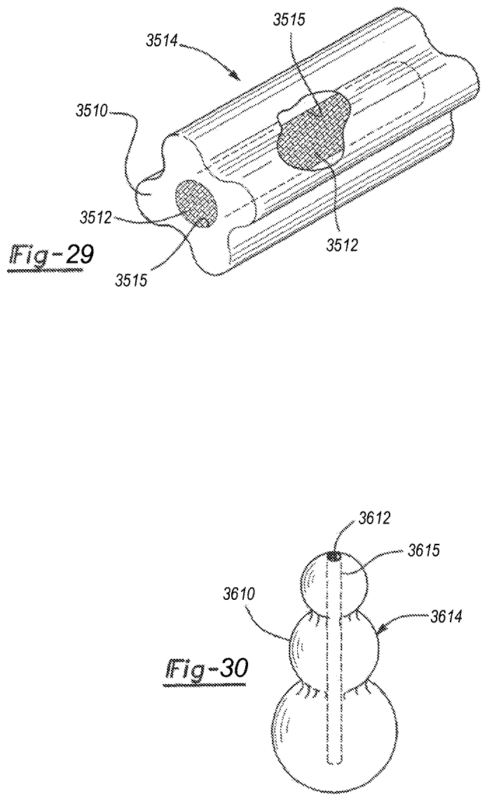

Another molded form is shown in FIG. 29 where the pet chew 3514 has the molded outer shell 3510 of plant based material with a longitudinal extending cavity 3515 filler with jerky material 3512. The molded cavity 3510 may have a clover leaf cross-sectional configuration as shown.

In a modified embodiment shown in FIG. 30, the outer casing 3610 of grain-based material may have a three ball configuration surrounding longitudinal cavity 3615 filled with jerky 3612.

The above specification, examples and data provide a complete description of the manufacture and use of disclosed compositions. Since many embodiments of the disclosure can be made without departing from the spirit and scope of the invention, the invention resides in the claims hereinafter appended.

1. A pet chew comprising:
a first sheet configured to be shaped into the pet treat which comprises a grain-based material with one or more auxiliary ingredients.
a second sheet comprising a meat based composition.

2. The pet chew of claim 1, wherein the second sheet comprises a meat selected from a group consisting of pork, beef, chicken, duck, goat, horse, buffalo, venison, elk, moose, liver, fish, veal, lamb, turkey, goose and combinations thereof.

3. The pet chew of claim 1, wherein the grain-base material comprises a grain or starch selected from a group consisting of quinoa, barley, brown rice, farro, amaranth, buckwheat, spelt, psyllium husk, ground flaxseeds, chickpeas, lima beans, squash, parsnips and oats.

4. The pet chew of claim 1, wherein the first sheet is substantially free of rawhide.

5. The pet chew of claim 1, wherein the first sheet is substantially free of wheat or rice.

6. The pet chew of claim 1, wherein the one or more auxiliary ingredients comprise a plant material selected from a group consisting of apple, apricot, banana, blackberry, blackcurrant, blueberry, coconut, cherry, cherimoya, date, durian, fig, feijoa, gooseberry, grape, grapefruit, jackfruit, jambul, kiwifruit, kumquat, lemon, lime, loquat, lychee, mango, mangosteen, melon, cantaloupe, honeydew, watermelon, nectarine, orange, passionfruit, peach, pear, plum, prune, pineapple, pomegranate, pommelo, raspberry, rambutan, redcurrant, satsuma, strawberry, tangerine, ugli fruit, artichoke, asparagus, avocado, bamboo shoots, bean sprouts, beans, beet, endive, bell pepper, broccoli, brussels sprouts, cabbage, calabaza, carrot, cauliflower, celery, cucumber, radish, eggplant, garlic, fiddlehead, galangal, ginger, beet greens, collard greens, dandelion greens, kale, mustard, spinach, Swiss chard, turnip greens, Jerusalem artichoke, jicama, lettuce, mushrooms, okra, onion, parsley, peas, peppers, plantain, pumpkin, radicchio, radish, rutabaga, spinach, sweet potato, tomato, turnip, water chestnut, yams, and combinations thereof.

7. The pet chew of claim 1, wherein the one or more auxiliary ingredients include a binding agent, a moisturizing compound, a salt, a sugar, an acid, a mold inhibitor, a flavoring compound, an aroma compound, a coloring compound or any combination thereof.

8. The pet chew of claim 1, wherein the one or more auxiliary ingredients include a health ingredient selected from the group consisting of glucosamine, chondroitin, flax seed, calcium, parsley seed, peppermint, chlorophyll, vitamin E, L-carnitine, lycopene, or mixtures thereof.

9. The pet chew of claim 1, wherein the first sheet contains no rawhide.

10. The pet chew of claim 1, wherein the first sheet contains no wheat or rice.

11. A pet chew comprising:
a first layer comprising a plant based material; and
a second layer comprising a chewy edible material, wherein the first and second layer form a pet treat.

12. The pet chew of claim 11, wherein the first layer is formed from a sheet of the plant-based material.

13. (canceled)

14. (canceled)

15. The pet chew of claim 11, wherein the first layer and the second layer comprise one ingredient from each of the respective combination of ingredients, the combination of ingredients being banana and peanut butter; spinach and cheese; and pumpkin and oats.

16. The pet chew of claim 11, further comprising an aroma or flavoring compound, selected from a group consisting of garlic, onion, natural smoke flavor, hickory, mesquite, tikka, tandoori, parsley, spinach, saffron, cheese, peanut butter, almond butter, and combinations thereof.

17. The pet chew of claim 16, wherein the aroma compound or flavoring compound is in an amount between about 1% and 5% by weight of the plant mixture.

18. The pet chew of claim 11, further comprising a coloring compound and wherein the pet chew is free of FD&C colors.

19. The pet chew of claim 11, further comprising a humectant selected from a group consisting of fructose, dextrose, maltodextrin, honey, high-fructose corn syrup, maltose, brown sugar, coconut sugar, date sugar, sucanat, molasses, turbinado sugar, dextrin, glucose, sucrose, sucralose, glycerin, and combinations thereof.

20. The pet chew of claim 11, wherein the pet chew is free, or substantially free, of gluten, soy, artificial flavors and rawhide.

21. A method of forming an edible pet chew comprising the steps of:
providing a plant based mixture that is extrudable and initially malleable;
forming said initially malleable plant based mixture into a first layer;
providing a second layer made from a vegetable and/or fruit composition;
placing said first and second layers in superimposed relation and rolling said first and second layers up to have said first layer and second layer forming alternating layers; and
hardening said first layer after it is wrapped with said second layer, thereby forming an edible pet chew.

22. The method of claim 21, further comprising: tying the ends of said edible pet chew into knots before hardening said first layer.

23.-30. (canceled)

31. The pet chew of claim 2, wherein the second sheet further comprises an anti-oxidant rich material selected from a group consisting of acai berries, blueberries, blackberries, spinach, brown rice, quinoa, chia seeds, flax seeds, wheat grass, pumpkin, salmon, kiwi, and asparagus.

32.-36. (canceled)

37. The pet chew of claim 31, wherein the meat is chicken breast jerky.

38. The pet chew of claim 31, wherein the anti-oxidant rich material is present in the amount of at least 4 wt %.
